(19) United States
(12) Patent Application Publication
(10) Pub. No.: US 2021/0276723 A1
(43) Pub. Date: Sep. 9, 2021

(54) POWER ASSEMBLY, POWER SYSTEM AND UNMANNED AERIAL VEHICLE

(71) Applicant: SZ DJI TECHNOLOGY CO., LTD., Shenzhen (CN)

(72) Inventor: Jiexing HAN, Shenzhen (CN)

(73) Assignee: SZ DJI TECHNOLOGY CO., LTD., Shenzhen (CN)

(21) Appl. No.: 17/321,498

(22) Filed: May 17, 2021

Related U.S. Application Data
(63) Continuation of application No. PCT/CN2018/118416, filed on Nov. 30, 2018.

(51) Int. Cl. B64D 27/24; B64C 39/02; B64C 29/00; B64D 27/10; B60L 50/16

(52) U.S. Cl. CPC B64D 27/24; B64C 39/024; B64C 29/0025; B64D 27/10; B64D 2027/026; B64C 2201/042; B64C 2201/048; B64C 2201/104; B64C 2201/021; B60L 50/16

(57) ABSTRACT

A power assembly, a power system including the power assembly and an unmanned aerial vehicle (UAV) including the power system are disclosed. The power assembly may include an engine, a transmission mechanism, an electrical generator, and a battery. The transmission mechanism may include a first drive shaft and a second drive shaft, both of which may be transmittingly connected to an output shaft of the engine. The first drive shaft may be used to drive a propulsion propeller of the UAV to rotate, and the second drive shaft may be used to drive the electrical generator to generate electricity. The electrical generator may be electrically connected to the battery to charge the battery. The battery may be used to drive rotors of the UAV to rotate.

### CROSS-REFERENCE TO RELATED APPLICATION

The present application is a continuation of International Application No. PCT/CN2018/118416, filed Nov. 30, 2018, the entire contents of which being incorporated herein by reference in its entirety.

### TECHNICAL FIELD

The present disclosure relates to the technical field of aircraft, particularly relates to a power assembly, a power system and an unmanned aerial vehicle.

### BACKGROUND

Unmanned aerial vehicle (UAV) is an unmanned aircraft operated by radio remote control equipment and program control device, which has several advantages, such as low cost to operate and manufacture, and convenient use. It has been widely used in various fields of daily life, for example, using UAVs for photo-shooting, detection, transportation, and many more.

The driving system of a UAV may be a pure electric system. The driving system may include a battery, a motor and a rotor. The battery provides electrical energy for the operation of the motor, and the motor further drives the rotation of the rotor to achieve the flight of the UAV. However, the weight of the battery accounts for a large proportion of the weight of the UAV, and the weight of the UAV will not become lighter during the flight. Therefore, the flight time and flight distance of the UAV with this type of driving system will be limited. The battery can only provide UAV for a limited-distance flight at a time.

The driving system of a UAV may also adopt a fuel-powered system. The driving system may include fuel, an engine, and wings. The engine uses fuel to power the UAV. This type of UAV can achieve a long-time and long-distance flight. However, because the engine itself is relatively heavy, the UAV is bulky and inconvenient to be carried. Also, the UAV is difficult to realize the rotor-driven flight due to the limitation of the fuel engine structure. Therefore, it is difficult to realize vertical take-off and landing, and consequently the use of this type of UAV is very limited.

The driving system of a UAV may also use a hybrid driving system. The UAV can use a battery for vertical take-off and landing and a fuel engine for cruise. However, because the UAV is still bulky, the carried battery usually makes the UAV have only one chance of hovering and landing, which limits the use of the UAV during the flight.

### SUMMARY

Some embodiments of the present disclosure provide a power assembly, a power system and an unmanned aerial vehicle (UAV). The technical features disclosed herein can extend the flight time and hovering times of a UAV. One example of the present disclosure is directed to a vertical take-off and landing fixed-wing UAV, which uses rotors for vertical take-off and landing, and uses a propulsion propeller for horizontal flight. This type of UAV is mainly used for long-distance flight rather than hovering. When the UAV flies horizontally, the rotors of UAV may stop rotating or rotate slowly to reduce energy consumption since the wings can generate lift. The technology of the present disclosure may not be applied to a conventional multi-rotor UAV because the rotors of the conventional multi-rotor UAV generate all the lift when the conventional multi-rotor UAV is in level flight (i.e., in horizontal flight).

Some embodiments of the present disclosure are also directed to other types of UAV that do not use motors to drive rotors to generate lift when the UAV flies horizontally, including vertical take-off and landing autogiro-UAV (rotors rotate to generate lift under the action of wind instead of being driven by motors) and airship UAV (in a level flight, the buoyancy is generated completely by an inflated airbag, and the rotors can assist in generating lift only during take-off and landing).

One embodiment of the present disclosure provides a power assembly for driving a UAV comprising a propulsion propeller and rotors. The power assembly may include an engine, a transmission mechanism, an electrical generator, and a battery. The transmission mechanism may include a first drive shaft and a second drive shaft, both of which may be transmittingly connected to an output shaft of the engine. The first drive shaft may be used to drive rotation of the propulsion propeller, and the second drive shaft may be used to drive the electrical generator to generate electricity. The electrical generator may be electrically connected with the battery to charge the battery. The battery may be used to drive rotation of the rotors. The propulsion propeller may produce horizontal thrust, and the rotors may produce upward thrust (lift).

Another embodiment of the present disclosure provides a power system, including: a propulsion propeller, a plurality of rotors, a plurality of motors, and the power assembly as described above. Each of the rotors may be fixed on an output shaft of each corresponding motor, respectively. The motors may be connected to the battery and the power module.

Another embodiment of the present disclosure provides an unmanned aerial vehicle, including: a flight control system and the power system as described above. The power system may include a propulsion propeller, a plurality of rotors, a plurality of motors and a power assembly. The power assembly may include an engine, a transmission mechanism, an electrical generator, and a battery. The transmission mechanism may include a first drive shaft and a second drive shaft, both of which may be transmittingly connected to an output shaft of the engine. The first drive shaft may be used to drive rotation of the propulsion propeller, and the second drive shaft may be used to drive the electrical generator to generate electricity. The electrical generator may be electrically connected to the battery to charge the battery that is used to drive rotation of the rotors.

Some embodiments of the present disclosure provide a solution that an engine is used to charge a battery of UAV while driving a vertical propeller, so that the UAV does not need to be equipped with a large battery, thereby reducing the total weight of the UAV, and prolonging the horizontal flight time of the UAV. While the battery drives the rotors of UAV, the consumed power of the battery can be replenished by the engine. As such, the UAV can perform multiple hovering tasks during a flight mission.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art can obtain other drawings and features based on these disclosed drawings without creative work.

FIG. 1 illustrates a schematic structural diagram of a power assembly according to an embodiment of the present disclosure;

FIG. 2 illustrates a schematic structural diagram of a power assembly according to an embodiment of the present disclosure;

FIG. 3 illustrates a schematic structural diagram of a power assembly according to an embodiment of the present disclosure;

FIG. 4 illustrates a schematic structural diagram of a power system according to an embodiment of the present disclosure;

FIG. 5 illustrates a schematic structural diagram of a UAV according to an embodiment of the present disclosure;

FIG. 6 illustrates a diagram of energy flow in a UAV according to an embodiment of the present disclosure;

FIG. 7 illustrates a diagram of energy flow in a UAV according to an embodiment of the present disclosure;

FIG. 8 illustrates a diagram of energy flow in a UAV according to an embodiment of the present disclosure; and

FIG. 9 illustrates a diagram of energy flow in a UAV according to an embodiment of the present disclosure.

### DETAILED DESCRIPTION

The technical solutions and technical features encompassed in the exemplary embodiments of the present disclosure will be described in detail in conjunction with the accompanying drawings in the exemplary embodiments of the present disclosure. Apparently, the described exemplary embodiments are part of the embodiments of the present disclosure, not all of the embodiments. Based on the embodiments and examples disclosed in the present disclosure, all other embodiments obtained by those of ordinary skill in the art without creative work shall fall within the protection scope of the present disclosure.

The chart(s) and diagram(s) shown in the drawings are only examples, and does not necessarily include all components, elements, contents and/or operations/steps, nor does it have to be arranged in the described or specific order. For example, some components/elements can also be disassembled, combined or partially combined. Therefore, the actual arrangement may be changed or modified according to actual conditions. In the case of no conflict, the components, elements, operations/steps and other features disclosed in the embodiments may be recombined with one another.

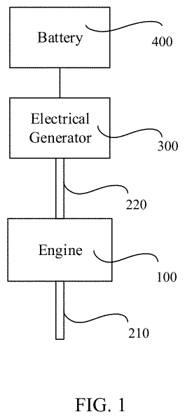

According to one aspect of the present disclosure, a power assembly is provided. FIG. 1 illustrates a schematic structural diagram of a power assembly according to one embodiment of the present disclosure. The power assembly is provided for driving a UAV equipped with a propulsion propeller and rotors. The power assembly may include an engine 100, a transmission mechanism, an electrical generator 300, and a battery 400. The transmission mechanism may include a first drive shaft 210 and a second drive shaft 220, both of which are transmittingly connected to an output shaft of the engine 100. The first drive shaft 210 is used to drive the propulsion propeller to rotate, and the second drive shaft 220 is used to drive the electrical generator 300 to generate electricity. The electrical generator 300 is electrically connected to the battery 400 to charge the battery 400. The battery 400 is used to supply power to a rotor power mechanism that drives the rotors to rotate.

In certain embodiments, the power assembly disclosed herein may be used in an aircraft such as a UAV. The power assembly may include an engine 100, which may be a turboshaft engine. Understandably, the engine 100 may also be an internal combustion engine. An output shaft of the engine 100 may be transmittingly connected to a first drive shaft 210 and a second drive shaft 220. The first drive shaft 210 may be used to drive a propulsion propeller of the UAV to rotate, so that the UAV maintains a horizontal flight state. The second drive shaft 220 may be used to drive an electrical generator 300 to generate electricity, and the electric energy generated by the electrical generator 300 can charge a battery 400. The battery 400 can supply power to a rotor power mechanism that drives rotors of UAV to rotate, so that the UAV can achieve vertical take-off and landing or maintain a hovering state. The rotor power mechanism may include components such as rotor motors and electronic governors. The hovering time of the UAV is affected by the electric energy stored in the battery 400 or related control signals. When the UAV changes from a hovering state to a horizontal flight state, the power loss of the battery 400 can be replenished by the electrical generator 300, thereby allowing the UAV to complete multiple hovering tasks during a flight mission. In addition, the battery 400 of the power assembly according to one embodiment of the present disclosure only needs to maintain the hovering mission at least once, and there is no need to equip with a large battery, thereby reducing the weight of the power assembly and prolonging the flight time of the UAV. The hovering state mentioned above refers to a state that the UAV relies on the rotors to generate lift, vertically ascending and descending or standing still, or moving at a low speed.

Optionally, the first drive shaft 210 and the second drive shaft 220 are transmittingly connected with an output shaft of the engine 100. The first drive shaft 210 is used to drive the propulsion propeller. The second drive shaft 220 is used to drive the electrical generator 300. The generator 300 is electrically connected with the battery 400, so that the engine 100 may charge the battery 400 while driving the vertical propeller (the propulsion propeller), thereby eliminating the need to carry a large battery and reducing the total weight of the power assembly. Since the battery 400 may drive the rotors, and the depleted power in the battery 400 can be replenished by the engine 100, the time of period for using the battery 400 to drive the rotors may be prolonged.

In certain embodiments, a first drive shaft 210 and a second drive shaft 220 may be started at the same time or stopped at the same time. That is, an engine 100 synchronously drives the first drive shaft 210 and the second drive shaft 220 to rotate, so as to drive an electrical generator 300 to generate electricity while driving a propulsion propeller. As such, the UAV can charge a battery 400 during horizontal flight.

In certain embodiments, the operating time range of a second drive shaft 220 may be within the operating time range of a first drive shaft 210. That is, the time range during which an engine 100 drives the second drive shaft 220 to rotate falls within the time range during which the engine 100 drives the first drive shaft 210 to rotate, so that the UAV can selectively drive an electrical generator 300 to generate electricity while driving the propulsion propeller. Thus, the UAV can selectively charge a battery 400 during horizontal flight, that is, it can choose to stop driving the second drive shaft 220 after the battery 400 is fully charged, and only drive the first drive shaft 210 to maintain the horizontal flight of the UAV.

In certain embodiments, the power assembly may further include a clutch mechanism for controlling the transmission connection state between an output shaft of an engine 100 and a second drive shaft 220. The rotation state of the second drive shaft 220 is controlled by controlling the clutch mechanism.

In certain embodiments, the power assembly may further include a first transmission gear train and a second transmission gear train. The first transmission gear train is used for drivingly connecting an output shaft of an engine 100 with a first drive shaft 210, and the second transmission gear train is used for drivingly connecting the output shaft of the engine 100 with a second drive shaft 220. The first transmission gear train and the second transmission gear train, without intend to limit, may be planetary gear systems. The specific structure of the first transmission gear train and second transmission gear train may also be set according to actual needs.

In certain embodiments, the power output from an engine 100 to a propulsion propeller may be made greater than the power output from the engine 100 to an electronic generator 300, and most of the power of the engine 100 is output to a first drive shaft 210 to maintain the horizontal flight of a UAV. A small part of the power of the engine 100 is output to an electrical generator 300 to charge a battery 400 to replenish the depleted power of the battery 400.

In certain embodiments, a first drive shaft 210 extends in a first direction to be in transmission connection with a propulsion propeller; and a second drive shaft 220 extends in a second direction to be in transmission connection with an electrical generator 300.

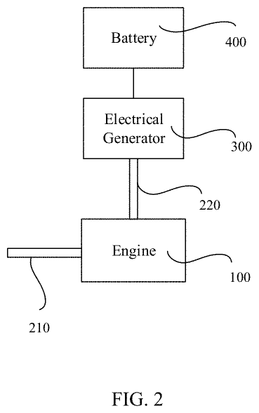

In certain embodiments, as shown in FIG. 1, the angle between the first direction and the second direction may be 180°. FIG. 2 illustrates a schematic structural diagram of a power assembly according to an embodiment of the present disclosure. As shown in FIG. 2, in certain embodiments, the first direction may be perpendicular to the second direction.

Of course, it would be appreciated to those skilled in the art that the angle value between the first direction and the second direction may be set according to actual needs, which is not limited to the above-mentioned embodiments.

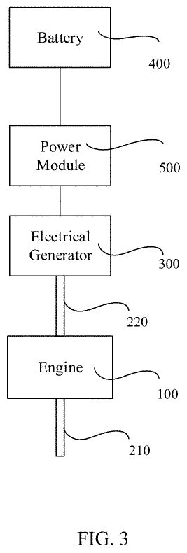

FIG. 3 illustrates a schematic structural diagram of a power assembly according to an embodiment of the present disclosure. As shown in FIG. 3, the power assembly may further include a power module 500. An electrical generator 300 is electrically connected to a battery 400 through the power module 500. The power module 500 may regulate the charging power of the electrical generator 300 to the battery 400, so that the charging voltage is more stable, which is beneficial to extend the service life of the battery 400.

In certain embodiments, a power module 500 may also be used to provide driving power to rotors, that is, the power module 500 can make the electric energy generated by an electrical generator 300 to directly drive the rotors to maintain the hovering state of a UAV. The hovering state of the UAV can be maintained by a battery 400 and the electrical generator 300 together, thereby reducing the charging time of the battery 400. As such, the UAV can perform multiple hovering tasks in a short time.

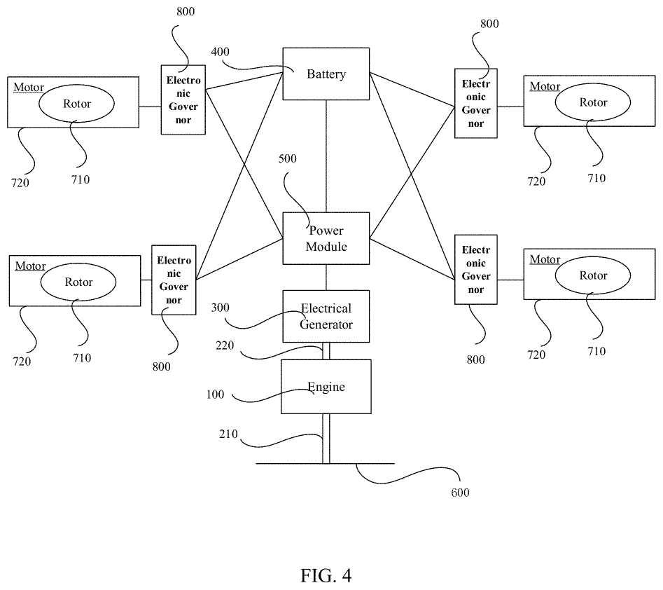

According to an aspect of the present disclosure, a power system is provided. FIG. 4 illustrates a schematic structural diagram of a power system according to an embodiment of the present disclosure. As shown in FIG. 4, the power system may include a propulsion propeller 600, a plurality of rotors 710, a plurality of motors 720, and a power assembly as disclosed above. Each of the rotors 710 is fixed on an output shaft of a respective motor 720. The motors 720 are electrically connected to a battery 400 and a power module 500.

In certain embodiments, the power system can be adapted to an aircraft such as a UAV. The power system may include an engine 100, a transmission mechanism, an electrical generator 300, a battery 400, a power module 500, a propulsion propeller 600, a plurality of rotors 710, and a plurality of motors 720. The number of rotors 710 and motors 720 may be set according to requirements, for example, four rotors 710 and four motors 720 are provided in FIG. 4. A rotor power mechanism may include the motors 720. An output shaft of the engine 100 is transmittingly connected to a first driving shaft 210 and a second driving shaft 220, respectively. The first driving shaft 210 is transmittingly connected to the propulsion propeller 600, and drives the propulsion propeller 600 to rotate so that the UAV can maintain a horizontal flight state. The second drive shaft 220 is in transmission connection with the electrical generator 300 to drive the electrical generator 300 to generate electricity. The electrical generator 300 is electrically connected to the battery 400 through the power module 500. When the UAV is flying horizontally, the electrical generator 300 may charge the battery 400 through the power module 500 to replenish the power depleted of the battery 400 and ensure that the UAV can smoothly execute the next hovering. When the UAV is hovering, the electrical generator 300 may supply power to the motors 720 through the power module 500, thereby directly driving the rotors 710 and reducing the power consumption in the battery 400. Through the above method, the power system according to an embodiment of the present disclosure can make the UAV complete multiple times of hovering during a flight mission. Therefore, the power system does not need to be equipped with a larger battery, thereby reducing the weight of the power system and prolonging the flight time of the UAV.

Owing to the above-mentioned power system, the engine 100 can charge the battery 400 while driving the propulsion propeller 600, so that the power system does not need to carry a large battery. Compared with the existing technology, the total weight of the power system is reduced. When the battery 400 supplies power to the motors 720 that drive the rotors 710, the power consumed in the battery 400 can be replenished by the engine 100. As such, the time of period for using the battery 400 to drive the rotors is extended.

In certain embodiments, the power system may further include electronic governors 800, which are electrically connected to the motors 720 and are used to control an operating state of the motors 720. The operating state of the motors 720 may include one or more of rotation speed, steering, angular velocity, and acceleration. By controlling the operating state of the motors 720, the UAV may be kept in balance.

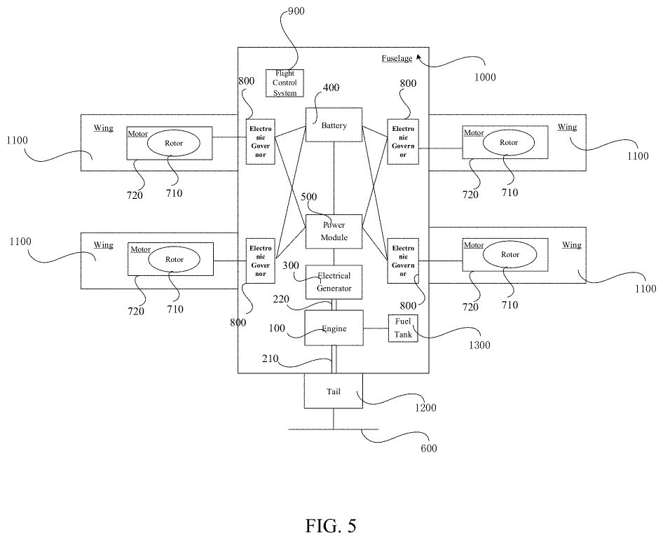

According to an aspect of the present disclosure, a UAV comprising a power system described above is provided. FIG. 5 illustrates a schematic structural diagram of a UAV according to an embodiment of the present disclosure. As shown in FIG. 5, the UAV may include a flight control system 900 and a power system disclosed above.

In certain embodiments, the UAV may include a fuselage 1000, wings 1100 and a tail 1200. The wings 1100 are arranged on the sides of the fuselage 1000. The specific number of the wings 1100 may be set as required, for example, four wings 1100 are arranged symmetrically on the sides of the fuselage 1000, i.e., two on each side of the fuselage 1000 symmetrically, as shown in FIG. 5. The tail 1200 is arranged at the rear end of the fuselage 1000 in the forward direction. The fuselage 1000 is used to install the power system. An engine 100, a transmission mechanism, an electrical generator 300, a battery 400, a power module 500, a propulsion propeller 600, a plurality of rotors 710, a plurality of motors 720 and a plurality of electronic governors 800 are respectively installed at different positions on the fuselage 1000, and constitute two sets of power systems. Among them, a first power system used to maintain the hovering of the UAV includes the engine 100, a second drive shaft 220, the electrical generator 300, the battery 400, the power module 500, the plurality of rotors 710, the plurality of motors 720, and the plurality of electronic governors 800. A second power system used to maintain the horizontal flight of the UAV includes the engine 100, a first drive shaft 210 and the propulsion propeller 600. Each rotor 710 is fixed on an output shaft of a corresponding motor 720, respectively, and each wing 1100 is provided with a motor 720. The propulsion propeller 600 is fixed on the tail of the fuselage 1000.

In addition, in certain embodiments, the rotors 710 may also be directly arranged on the fuselage 1000, the number of the rotors 710 may be set as needed, and the plurality of rotors 710 may be arranged radially and symmetrically. The rotors 710 may be directly installed on the upper surface or the lower surface of the fuselage 1000 and/or connected with the fuselage 1000 by branch rods. The installation angle and position of the rotors 710 are not limited, for example, one or more of the rotors 710 may also be installed on the tail 1200.

A fuel tank 1300 may also be provided in the fuselage 1000, and the fuel tank 1300 is used to provide fuel for the engine 100.

The flight control system 900 may be connected to the engine 100, the electrical generator 300, the electronic governors 800, the battery 400 and the power module 500, and may regulate the operating status of each component.

In certain embodiments, a variety of sensors may also be provided, and the sensors are connected to the flight control system 900, so that the flight control system 900 may sense the current flight status of the UAV.

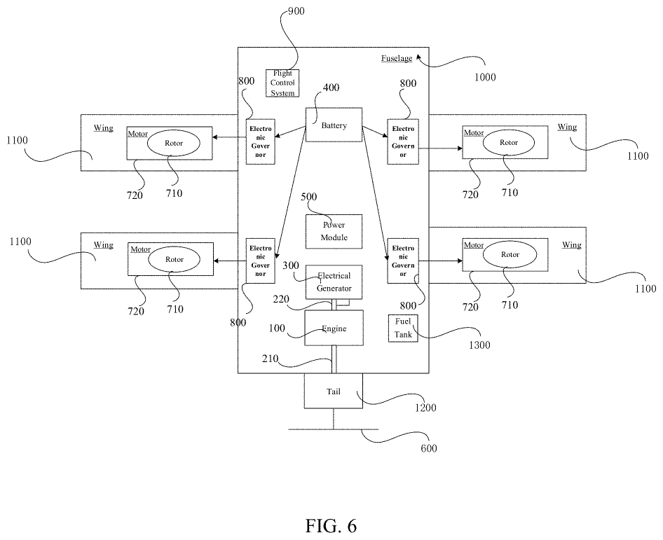

FIG. 6 illustrates a diagram of energy flow in a UAV according to an embodiment of the present disclosure. As shown in FIG. 6, in certain embodiments, when the UAV is hovering, rotors 710 may only be driven by a battery 400 to rotate. At this time, the energy in the battery 400 is sufficient to maintain the hovering of the UAV for a preset time, and the energy in the battery 400 passes through electronic governors 800 and motors 720 to reach rotors 710 to maintain the hovering state of the UAV.

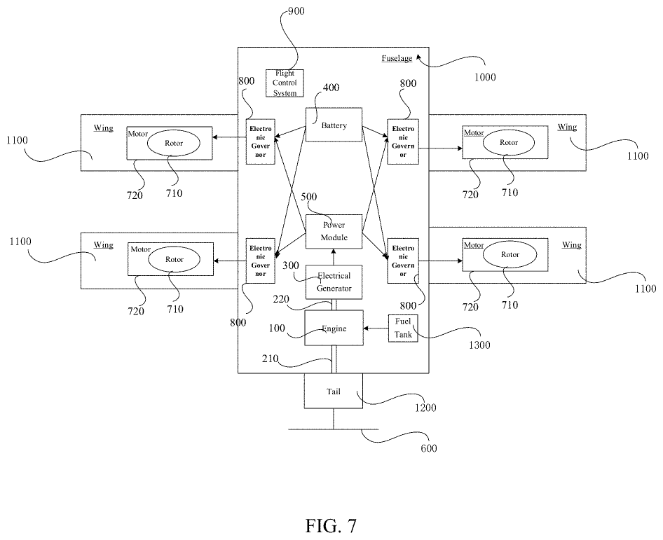

FIG. 7 illustrates a diagram of energy flow in a UAV according to an embodiment of the present disclosure. As shown in FIG. 7, in certain embodiments, when the UAV is hovering, a battery 400 and a power module 500 may jointly drive rotors to rotate. At this time, the energy in the battery 400 is not enough to maintain the hovering of the UAV for a preset time, and the power module 500 may be employed to drive rotors 710 together. Optionally, a fuel tank 1300 provides fuel for an engine 100, and the engine 100 drives an electrical generator 300 to operate. The electric energy generated by the generator 300 and the electric energy stored in the battery 400 pass through electronic governors 800 and motors 720 to reach the rotors 710 concurrently, and jointly drive the rotors 710 to rotate. As such the UAV can maintain hovering for a preset time.

When the UAV is in a hovering state, a flight control system 900 also controls an operating state of the motors 720 through the electronic governors 800 according to the hovering state of the UAV.

The operating state of the motors 720 may include one or more of rotation speed, steering, angular velocity, and acceleration. By controlling the operating state of the motors 720, the UAV may keep balance in the current state.

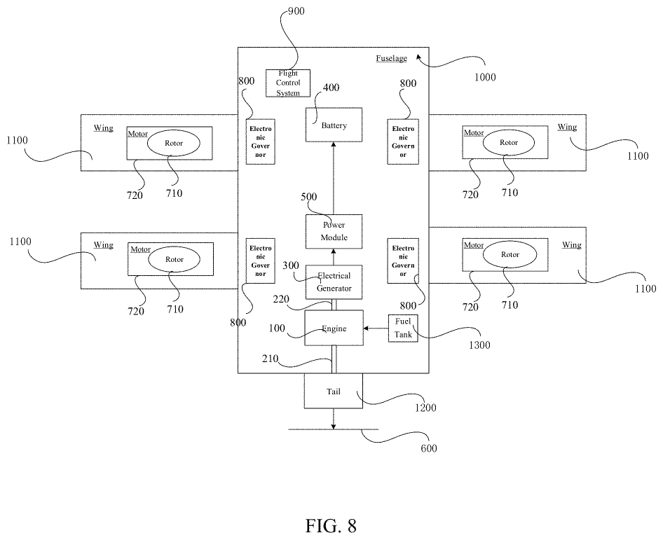

FIG. 8 illustrates a diagram of energy flow in a UAV according to an embodiment of the present disclosure. As shown in FIG. 8, in certain embodiments, when the UAV is in horizontal flight, a portion of the output power of an engine 100 may be used to drive an electrical generator 300. Another portion of the output power of the engine 100 may be used to drive a propulsion propeller 600. At this time, the UAV may charge a battery 400 when it is flying horizontally to replenish the power depleted in the battery 400 and prepare for the next hovering mission of the UAV. Optionally, a fuel tank 1300 provides fuel for the engine 100, and the engine 100 drives a first drive shaft 210 and a second drive shaft 220 to rotate at the same time. The first drive shaft 210 drives a propulsion propeller 600 to maintain the horizontal flight state of the UAV. The second drive shaft 220 drives the electronic generator 300 to generate electricity, and the electrical energy generated by the electronic generator 300 passes through a power module 500 to charge the battery 400 to replenish the consumed electrical energy in the battery 400.

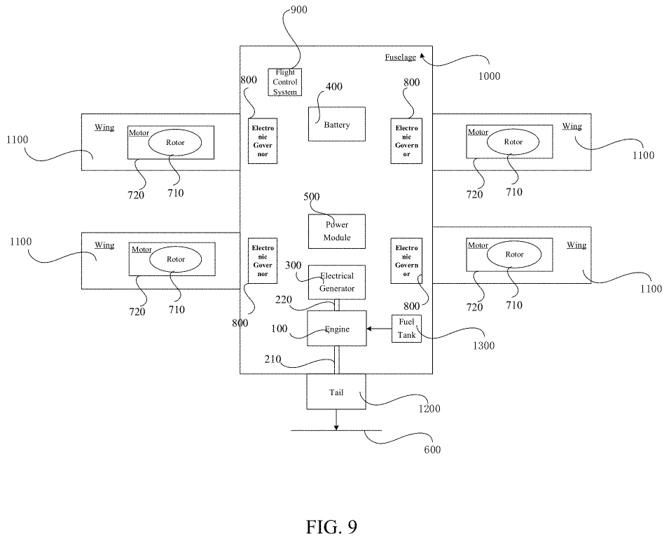

FIG. 9 illustrates a diagram of energy flow in a UAV according to an embodiment of the present disclosure. As shown in FIG. 9, in certain embodiments, when the UAV is in horizontal flight, all the output power of an engine 100 may be used to drive a propulsion propeller 600. At this time, a battery 400 does not need to be charged (for example, the battery 400 is fully charged, or the remaining power is sufficient for subsequent hovering use). Optionally, a fuel tank 1300 provides fuel for the engine 100, the engine 100 drives a first drive shaft 210 to rotate, and the first drive shaft 210 drives the propulsion propeller 600 to maintain the horizontal flight state of the UAV.

When the UAV is in a horizontal flight state, a flight control system 900 may be also used to control the charging time of the battery 400 by a power module 500 according to the current energy of the battery 400 and the power of an electrical generator 300. The charging time is affected by the amount of charge per unit time, and is related to the specific structure of the engine 100, the transmission mechanism, the electrical generator 300, the power module 500 and the battery 400.

In certain embodiments, after a battery 400 is fully charged, it may drive the UAV to hover for at least 1 minute. The specific time may be set according to the take-off and landing time.

In certain embodiments, when the UAV is in a horizontal flight state, a flight control system 900 may also be used to adjust a ratio of a power output from an engine 100 to a propulsion propeller 600 to a power output from the engine to an electrical generator 300 according to a state of the UAV when the UAV is flying horizontally. The state of the UAV during horizontal flight includes the power required to maintain the UAV in horizontal flight and the power required to charge a battery 400.

Optionally, the specific value of the power required to maintain the horizontal flight of the UAV and the power required to charge the battery 400 can be determined after processing, by the flight control system 900, the data captured by corresponding sensors during the horizontal flight of the UAV. Thus, the ratio of the output power of the engine 100 to the propulsion propeller 600 to the output power of the engine 100 to the electrical generator 300 can be adjusted.

The UAV according to some embodiments of the present disclosure utilizes the engine 100 to charge the battery 400 while driving the propulsion propeller 600. Therefore, the UAV does not need to be equipped with a large battery, which reduces the total weight of the UAV. Compared to the existing technology, it prolongs the UAV's horizontal flight time significantly. When the battery 400 drives the rotors 710, the power consumed in the battery 400 can be replenished by the engine 100. Thus, under the premise that the UAV has the same hovering time each time, compared with the existing technology, the number of hovering of the UAV is increased. In some cases, if the engine is turned off, the battery's power can allow the UAV to continue for 1 to 5 minutes and land.

The contents of embodiments disclosed above will be further explained by taking some following specific examples.

Assuming that a fixed-wing UAV has a take-off weight of 1 ton and is equipped with 8 rotors with a diameter of 2 meters, the hovering requires about 250 kW of power, and a battery is required to maintain hovering for 5 minutes. The UAV needs about 100 kW of axis power to fly horizontally at a speed of 200 km/h. The weight reserved by the UAV for the power system is 400 kg, which accounts for 40% of the take-off weight of UAV. This part of the weight is the weight of the fuel tank for a fuel UAV, the weight of the battery for a pure electric UAV, and the total weight of the electrical generator, the battery and the fuel tank for a UAV according to some embodiments of the present disclosure. Assuming that the energy density of the battery is 0.18 kWh/kg, the power density of an engine and the power density of a motor are about the same, about 2 kW/kg, and the power density of an electrical generator is 0.3 kW/kg.

When the UAV is a pure electric UAV. Under the weight of 1 ton, every minute of hovering needs to consume 23 kg of battery energy, and every minute of horizontal flight needs to consume 9.2 kg of battery energy. The battery is required to be able to hover for 5 minutes, and the remaining energy is used for cruising.

Taking-off and landing of the UAV alone requires power consumption of 20.8 kW·h, which consumes 115 kg of battery energy. The weight of the battery is calculated as 40% of the UAV, that is, 400 kg. The remaining 285 kg of battery energy may be used for horizontal flight, that is, the horizontal flight time is only 30 minutes. The battery life is generally only 200 to 500 charge and discharge cycles, which means that the UAV needs to change the battery frequently.

When the UAV is a fuel UAV, taking into account the loss of power generation efficiency, the taking-off and landing of the UAV requires an engine and an electrical generator with a power of more than 300 kW. However, when the UAV flies horizontally, it only needs ⅓ of the power that is needed when the UAV takes off and lands, and the engine needs to operate in a low-power state for a long time, which is not efficient. The weight of the electrical generator is also relatively heavy, and the cost of a high-power engine is high.

In one example of the present disclosure, a UAV may carry a small turboshaft engine, the engine power only needs 130 kW, of which 100 kW directly drives a propulsion propeller used for the horizontal flight of the UAV, and can drive a 30-kW electrical generator at the same time, that is, 30 kW of surplus power to charge a battery. The total weight of the power system and electrical generator is estimated to be 100 kg. Since the battery may be charged during the flight, including the energy of battery, the battery needs only to maintain 3 minutes hovering of the UAV, that is, 12.5 kWh, and a weight of only 69 kg. It only takes 30 minutes for the battery to be fully charged from fully discharged, which is equivalent to be able to have one hovering every 30 minutes. The remaining weight of the power system 231 kg is reserved for a fuel system, minus 20 kg of the fuel tank weight, the usable fuel weight is 211 kg. Even ignoring the weight loss caused by fuel consumption, based on the engine fuel consumption rate of 0.4 kg per kilowatt hour, the UAV may fly 3.5 hours, which is 7 times that of a pure electric UAV, and the engine power is only half of that of a fuel UAV.

In another example of the present disclosure, a UAV may carry a small turboshaft engine, the engine power only needs 120 kW, of which 100 kW directly drives a propulsion propeller used for the horizontal flight of the UAV, and can drive a 20-kW electrical generator at the same time, that is, 20 kW of surplus power to charge a battery. The total weight of the power system and electrical generator is estimated to be 67 kg. Since the battery may be charged during the flight, including the energy of the battery, the battery needs only to maintain 3 minutes hovering of the UAV, that is, 12.5 kWh, and a weight of only 69 kg. It only takes 45 minutes for the battery to be fully charged from fully discharged, which is equivalent to be able to have a hovering every 45 minutes. The remaining weight of the energy system 264 kg is reserved for a fuel system, minus 20 kg of the fuel tank weight, the usable fuel weight is 244 kg. Even ignoring the weight loss caused by fuel consumption, based on the engine fuel consumption rate of 0.4 kg per kilowatt hour, the UAV may fly 5 hours, which is 10 times that of a pure electric UAV.

In some examples, when a UAV according to some embodiments of the present disclosure only makes an intercity short-distance flight of about 200 km, it may carry about 200 kg more load than a pure electric UAV does.

Therefore, as long as a lightweight electrical generator is selected, a UAV according to some embodiments of the present disclosure can achieve a longer endurance than a pure electric UAV, and at the same time, the engine power required is much smaller than that of a fuel UAV. By optimizing the size of the engine and battery, the weight and cost of UAV can be reduced. For short-distance flights or frequent hovering, a larger electrical generator may be used, and for long-distance flights, a smaller generator may be selected with greater flexibility.

In the description of the present disclosure, it should be understood that the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial” , “radial”, “circumferential”, etc. indicate the orientation or positional relationship based on the orientation or positional relationship shown in the drawings, and are only for the convenience of describing the present disclosure and simplifying the description, and do not indicate or imply the described device or element must have a specific orientation, be constructed and operated in a specific orientation, and therefore it cannot be understood as a limitation of the present disclosure.

In the present disclosure, unless otherwise clearly specified and limited, the terms “installed”, “connected”, “linked”, “fixed” and other terms should be understood in a broad sense. For example, it can be a fixed connection or a detachable connection or integrated; it can be directly connected, or indirectly connected through an intermediate medium; it can be the internal communication of two elements or the interaction relationship between two elements. For those of ordinary skill in the art, the specific meaning of the above-mentioned terms in the present disclosure can be understood according to specific circumstances.

It should be noted that in the description of the present disclosure, the terms “first” and “second” are only used to facilitate the description of different components, and cannot be understood as indicating or implying the order relationship, relative importance or implicitly indicating the number of indicated technical features. Therefore, the features defined with “first” and “second” may explicitly or implicitly include at least one of the features.

It should be understood that the terms used in the specification of the present disclosure are only for the purpose of describing specific embodiments and are not intended to limit the disclosure. As used in the specification of the present disclosure and the appended claims, unless the context clearly indicates otherwise, the singular forms “a”, “an” and “the” are intended to include plural forms. It should also be understood that the term “and/or” used in the description of this disclosure and the appended claims refers to any combination of one or more of the associated listed items and all possible combinations, and includes these combinations.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A power assembly for driving an unmanned aerial vehicle (UAV), comprising:
an engine;
a transmission mechanism;
an electrical generator; and
a battery electrically connected to the electrical generator,
wherein the transmission mechanism comprises a first drive shaft and a second drive shaft, both of which are transmittingly connected to an output shaft of the engine;
the first drive shaft is configured to drive rotation of a propulsion propeller of the UAV;
the second drive shaft is configured to drive the electrical generator to generate electricity;
the electrical generator is configured to charge the battery; and
the battery is configured to supply power to a rotor power mechanism of the UAV that drives rotation of rotors of the UAV.

2. The power assembly of claim 1, wherein the first drive shaft and the second drive shaft start or stop at the same time.

3. The power assembly of claim 2, wherein an operating time range of the second drive shaft is within an operating time range of the first drive shaft.

4. The power assembly of claim 3, further comprising a clutch for controlling a transmission connection state between the output shaft of the engine and the second drive shaft.

5. The power assembly of claim 1, further comprising a first transmission gear train and a second transmission gear train,
wherein the first transmission gear train is configured to transmittingly connect the output shaft of the engine to the first drive shaft, and the second transmission gear train is configured to transmittingly connect the output shaft of the engine to the second drive shaft.

6. The power assembly of claim 5, wherein an amount of power output from the engine to the propulsion propeller is greater than an amount of power output from the engine to the electrical generator.

7. The power assembly of claim 1, wherein the first drive shaft extends in a first direction to be transmittingly connected to the propulsion propeller; and the second drive shaft extends in a second direction to be transmittingly connected to the electrical generator.

8. The power assembly of claim 7, wherein the first direction is perpendicular to the second direction, or an angle between the first direction and the second direction is 180°.

9. The power assembly of claim 1, further comprising a power module, wherein the electrical generator is electrically connected to the battery through the power module.

10. The power assembly of claim 9, wherein the power module is also configured to drive the rotation of the rotors.

11. The power assembly of claim 1, wherein the engine is a turboshaft engine.

12. A power system, comprising:
the power assembly of claim 9,
wherein the rotor power mechanism of the UAV comprises a plurality of motors, each of the rotors is respectively fixed on an output shaft of one of the plurality of motors, and the plurality of the motors is electrically connected to the battery and the power module.

13. An unmanned aerial vehicle (UAV), comprising: a flight control system and the power system of claim 12.

14. The UAV of claim 13, wherein the battery is configured to drive the rotation of the rotors during a time when the UAV is in a hovering state.

15. The UAV of claim 13, wherein during a time when the UAV is in a horizontal flight state, a portion of an output power of the engine is configured to drive the electrical generator, and another portion of the output power of the engine is configured to drive the propulsion propeller.

16. The UAV of claim 13, wherein during a time when the UAV is in a horizontal flight state, all the output power of the engine is configured to drive the propulsion propeller.

17. The UAV of claim 15, wherein the flight control system is configured to control a charging time of the battery by the power module based on current energy of the battery and a power of the electrical generator.

18. The UAV of claim 15, wherein the flight control system is configured to adjust a ratio of the portion of the power output from the engine to the propulsion propeller to the portion of the power output from the engine to the electrical generator based on a state of the UAV during a time when the UAV is in the horizontal flight state.

19. The UAV of claim 18, wherein the state of the UAV during the horizontal flight state comprises a power required to maintain the UAV in horizontal flight and a power required to charge the battery.

20. The UAV of claim 13, further comprising a fuselage, wings and a tail, wherein the wings are arranged on sides of the fuselage, the tail is arranged at a rear end of the fuselage in a forward direction, and the rotors are arranged radially and symmetrically around the fuselage.
